(19) United States
(12) Patent Application Publication
(10) Pub. No.: US 2022/0389187 A1
(43) Pub. Date: Dec. 8, 2022

(54) DURABLE GRAPHENE EXTERIOR PLASTIC COATING COMPOSITION

(71) Applicant: Illinois Tool Works Inc., Glenview, IL (US)

(72) Inventors: Tze-Lee Phang, Glenview, IL (US); John Isidoro Escoto, JR., Glenview, IL (US); Kimberly J. Vo, Glenview, IL (US); Vince Cipresso, Glenview, IL (US)

(73) Assignee: Illinois Tool Works Inc., Glenview, IL (US)

(21) Appl. No.: 17/824,971

(22) Filed: May 26, 2022

Related U.S. Application Data
(60) Provisional application No. 63/195,206, filed on Jun. 1, 2021.

(51) Int. Cl. C08K 3/04; C09D 183/04; C09D 7/63; C08K 5/5419

(52) U.S. Cl. CPC C08K 3/042; C09D 183/04; C09D 7/63; C08K 5/5419

(57) ABSTRACT

A composition is provided that restores and protects substrates to which it is applied including trim, headlight, or tires on vehicles. The composition includes reactive silicone silanes, graphene, and an adhesion promoter all dissolved or dispersed in a carrier oil or solvent. The composition forms a high adhesion high cohesion film that protects the underlying substrate from the adverse effects of ultraviolet (UV) rays, heat, rain, snow, and other environmental contaminants. A process of applying the same is also provided.

### RELATED APPLICATIONS

This application claims priority benefit of U.S. Provisional Application Ser. No. 63/195,206 filed Jun. 1, 2021; the contents of which are hereby incorporated by reference.

### FIELD OF THE INVENTION

The present invention in general relates to a composition for restoring and maintaining surfaces and a process for the use thereof and in particular, to such a composition amenable to application to a variety of substrates primarily related to vehicle trim or headlight plastic, or moldings.

### BACKGROUND OF THE INVENTION

The modern automobile and other transportation vehicles have an increased amount of exterior trim and moldings made of plastic and rubber based on their unique material properties. These materials, based primarily on polypropylene, provide aesthetics, light weight, corrosion resistance, strength, and flexibility of design. However, these polymers on the exterior of a vehicle, are almost constantly subjected to the adverse effects of ultraviolet (UV) rays, seasonal temperature changes, rain, snow, ozone, and other environmental contaminants. If not properly cared for, the weathering elements will cause the exterior trim and molding to age prematurely (degradation), and the surface of the trim to become dull, faded, and cracked.

Current consumer trim restoration products used to treat and restore faded exterior trim and moldings back to their near-show-room condition use silicone oil (e.g. polydimethylsiloxane (PDMS)) or wax in one of a water-based, solvent-based, or black dye pigment solution. While these trim restoration formulations are generally easy and safe for consumers to apply without specialized training or equipment, these formulations do not adhere strongly to the surface to which they are applied, nor do they form high adhesion and high cohesion films. Therefore, these consumer trim restoration formulations fail to endure car wash cycles and prematurely wear off from the applied surfaces that the formulations are intended to protect.

In the professional original equipment manufacturer (OEM) market, available trim restoration products utilize reactive chemistry to form a durable coating. However, these professional trim restoration products are very costly both chemically and in terms of required capital equipment. Current professional trim restoration products also require delicate process control to obtain a durable smooth finish. Moreover, these products are mostly toxic or harmful to the user and the environment.

Therefore, attempts to bring professional OEM trim restoration products to the consumer do-it-yourself (DIY) space present many challenges. A first challenge is the creation of a formulation that forms a good coating without streaking or bubbling, also are self-leveling and applied with a simple wipe-on application without complicated process control equipment so as to be suitable for an untrained consumer A second challenge relates to the difficulty of replacing solvents being used to dissolve the reactive chemistries thereby making the formulations safer for home usage and ideally with limited or no volatile organic compound (VOC) content.

Thus, there exists a need for a long lasting and durable vehicle trim and molding restoration composition for the consumer market that is easy to apply and is safe for the user and the environment. There also exists a need for sealant composition to protect headlight plastic surfaces.

### SUMMARY OF THE INVENTION

A restorative and protective composition for application to a substrate is provided that includes a silicone silane, a graphene slurry, a carrier, and an adhesion promoter. The composition leaves a durable film on a substrate when dried.

A process is provided for applying a restorative and protective film to a substrate. The process includes applying the composition that forms the restorative and protective film to the substrate and removing excess from the surface to form the film. The applying is with a spray or a liquid poured onto woven or non-woven fabric or sponge, or a soaked wipe.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings wherein:

FIGS. 1A and 1B are portions of a depiction of a vehicle trim part showing the trim part with a treated portion (FIG. 1A) treated with an embodiment of the inventive restorative and protective composition after five months and with an untreated portion (FIG. 1B) of the surface; and

FIGS. 2A-2C are portions of a depiction of an aged headlight that has hazy surface as shown in FIG. 2A, that was wet sanded and to which was applied an inventive composition to provide optical clarity and protection to the headlights (FIG. 2B), after 5 months, the treated headlight of FIG. 2B remained clear and protected from weathering (FIG. 2C).

### DETAILED DESCRIPTION OF THE PREFERRED EMBODIMENTS

The present invention has utility as a trim and molding restorative and protective composition that forms a coating on a plastic substrate to render the underlying substrate protected from the adverse effects of ultraviolet (UV) rays, heat, rain, snow, and other environmental contaminants. The present invention has the attribute of being amenable to application as a wipe-on or spray applied composition that forms a film without resort to the complex deposition processes that characterized prior art systems. Embodiments of the trim and molding restoration composition adhere strongly to the surface to which they are applied and form a high adhesion high cohesion film. Therefore, embodiments of the trim and molding restoration composition are able to endure car wash cycles and do not wear off rapidly from the applied target surfaces compared to conventional coatings. As a result of the durability of the restorative and protective film imparted to a substrate by the inventive composition, the substrate needs to have protective treatments less often. An inventive composition is also amenable to formulation independent of, and therefore devoid of volatile organic compounds (VOCs).

While the present invention is further detailed with respect to application to vehicle trim and molding such as a bumper cover, it is appreciated that an inventive composition is readily applied to numerous other substrates to impart protective films thereto. To the extent that an inventive composition is described herein with respect to total weight percentage of various components, these amounts are provided independent of propellants that are used in pressurized aerosol packages.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also, as used herein, “and/or” refers to and encompasses any and all possible combinations of one or more of the associated listed items, as well as the lack of combinations when interpreted in the alternative (“or”).

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

As used herein, a coating is defined as a layer of cured material having a thickness of between 0.01 and 1000 microns. As used herein a coating is synonymous with a film.

As used herein, molecular weight with respect to a polymeric material references to average number molecular weight as measured by gel permeation chromatography (GPC).

As used herein, graphene is defined as a two-dimensional material constructed by close-packed carbon atoms including a single-layer graphene, double-layer graphene, few-layer graphene, and graphene nanoplatelets.

As used herein double-layer graphene is defined as a stack graphene of two layers, few-layer graphene is defined as a stack of graphene of 3-10 layers, graphene nanoplatelet is defined as a stack of graphene of more than 10 layers. The graphene materials can be made by chemical or mechanical exfoliation of graphite, chemical vapor deposition, physical vapor deposition, microwave plasma, sonication/cavitation in solvent, organic synthesis, and epitaxy growth on a substrate.

As used herein, graphene oxide is defined as graphene with various oxygen-containing functionalities such as epoxide, carbonyl, carboxyl, and hydroxyl groups and a total oxygen content of 10-60 weight percent, typically around 20-50 weight percent.

As used herein, reduced graphene oxide is defined as graphene oxide that has been chemically or thermally reduced with a total oxygen content of typically in the range of 10-50 percent depending on the extent of the reduction.

As used herein, a nanoplatelet is defined as having planar dimensional in orthogonal direction of each independently between 2 and 20 nanometers.

An inventive composition is provided that provides a long lasting durable trim and molding restoration, protection, and shine coating based on a reactive silicone silane and graphene in a non-aqueous carrier to form a stable solution that is both clear and transparent in some inventive embodiments. Graphene in the composition weaves into the film matrix and imparts excellent hardness to the resulting residual shiny coating. In some embodiments of the present invention, an adhesion promoter is also present. In still other embodiments, the inventive composition includes a propellant to afford a pressurized aerosol container for dispensing onto a target substrate. Different application methods for embodiments of the hard surface treatment composition. illustratively include using aerosol spray, liquid spray, or wipes to deliver the hard surface treatment composition to the automotive and other hard surfaces.

A strong, durable, and lasting shine coating on a target substrate is obtained from an inventive composition. An inventive coating is obtained from the cured reaction product of reactive silicone silanes in which graphene is dispersed. Graphene weaves and interlocks into the matrix of the coating film, reinforcing the hardness and durable properties of the coating. Reactive silicone silanes operative in the present invention illustratively include polysilsesquioxanes, silicone MQ resins, and silicone MTQ resins, where M is (CH₃)₃SiO, Q is SiO₄, and T is (CH₃) SiO₃, with the proviso that at least one of M, Q, or T is modified to include a reactive terminal group of methoxy, ethoxy, dialkoyl, or trialkoxyl types. A polysilsesquioxane has a structure (RSiO_{3/2})ₙ where R is the moiety is C₁₋₃ alkyl, vinyl, C₁₋₃ fluoroalkyl, C₁₋₃ perfluoroalkyl, y-glycidoxypropyl, and γ-methacryloxypropyl; and n is an integer of from 4 to 5,000. The synthesis and application of precursors to form a polysilsesquioxane coating are conventional to the art, as shown for example in U.S. Pat. No. 3,944,702. An additional class of polysilsesquioxanes operative herein are multifunctional silsesquioxanes having at least two moieties per polyhedral assembly. The synthesis and application of precursors to form a ladder-type polysiloxanes, and other organo-functional silsesquioxanes coating are conventional to the art, as shown for example in U.S. Pat. Nos. 5,039,771; 5,047,492; 7,256,243; 7,868,198; and WO02/100867. Exemplary multi-functional polysilsesquioxanes operative herein include polycyclic octa-silsesquioxane, triethoxy silylethyl methyl siloxy silsesquioxane, tetrahydridodimuthylsiloxyoctasil, tetraoxyethanoltetratriathoxysilylethane silsesquioxane, (tetratriethoxysilylethyldimethylsiloxy)(tetraglycidyldimethylsiloxy)octa-silsesquioxane (TGTSE), and combinations thereof.

The reactive silicone silanes used in the current invention are cured on the target substrate to form a coating. The silicone silanes are selected to include silanol groups inclusive of hydroxyl moieties that impart solubility in a carrier and are cured on the target substrate for form the inventive coating. As a result, solvation of components of an inventive trim restoration is simplified compared to higher molecular weight materials that are merely deposited on the target substrate by solvent evaporation. A silicone oil or organic solvent is desirable in reducing volatile organic content (VOC) emissions in forming a coating compared to conventional compositions. Furthermore, curing on the substrate in some inventive embodiments yields coatings that are highly cross-linked and higher molecular weight as compared to solvent dissolved or dispersed pre-cured polymers resulting in greater durability coatings. Typical viscosity range of the neat reactive silicone silanes in the present invention are between 20 and 60,000 cps at 25° C. per ASTM D1200-10.

The condensation of silanol groups in the formulation interlocks graphene layers into the coating matrix, achieving the desired cure and results in coatings that are shinny when observed by an unaided normal human eye under sunlight illumination. The resulting graphene-based composite coatings are durable compared to convention trim and molding coatings due to graphene reinforcing the hardness and durability properties of a high degree of cure and adhesion to the target substrate. The cure in some inventive embodiments is accelerated by the addition of catalyst to the formulation.

Not to be limited to a particular theory, in inventive embodiments the graphene is provided in a powder forms or solvent based slurry. Graphene dispersed in a solvent slurry is typically present from 0.5 to 80 weight percent of the slurry. The low surface energy of graphene also complements silicones in the film coating to inhibit dirt and debris adhesion and hardens the resulting film coating against abrasion thereby significantly improving the trim and molding restoration composition. Furthermore, the graphene of the composition can be used to adjust the hydrophobic or hydrophilic properties of the treated surfaces. As a result, treated surfaces shed dust naturally, look cleaner/fresher, and require less manual maintenance.

Graphene is layered sp2 hybridized carbon atoms in a honeycomb-like, 2-dimensional sheet. Graphene is known to have excellent mechanical strength and flexibility, thermal and electric conductivities, and much higher optical cross section relative to many polymer coatings. Graphene as used in the present invention is mainly single layer and with distribution up to 5 layers. Typical loading of graphene in an inventive composition range from 0.005 to 30 total weight percent.

Graphene-type materials operative in the present invention include single-layer graphene, double-layer graphene, few-layer graphene, graphene oxide (GO), reduced graphene oxide (rGO), exfoliated graphene nanoplatelets, and ultra-thin graphite because all of these materials can enhance properties of compositions to which they are added.

In inventive embodiments of the trim restoration composition or headlight sealant composition, the graphene can be single layer graphene, few-layer graphene, or multi-layer graphene nanoplatelet, or a combination thereof. Graphene nanoplatelet is low cost and has an easy-handling nature as compared to single layer graphene. The thickness and size of graphene or graphene nanoplatelets can be adjusted to meet the processing requirements, coating quality, and coating performance needs. In addition to graphene or graphene nanoplatelet, other additives may be added in the formulation to provide different properties and functionalities. Such additives include but are not limited to graphite, carbon black, carbon fibers, carbon nanotubes, metallic or ceramic flakes or particles.

A carrier operative in the present invention dissolves or disperses the silicone silanes that upon cure form a composite matrix with the graphene to become the shine agent. Carriers operative herein include silicone oils that include specifically include decamethylpentasiloxane, hexamethylcyclotrisiloxane (D3), octamethylcyclo-tetrasiloxane (D4), decamethylcyclo-pentasiloxane (D5), dodecamethylcyclo-hexasiloxane (D6), hexamethyldisiloxane, combinations thereof, and oligiomeric forms that that have viscosities of from 2 to 10,000 centistokes (cSt); C₄-C₂₄ alkanes, C₂-C₂₄ alcohols, C₂-C₂₄ ketones, C₂-C₂₄ glycols, C₄-C₂₄ glymes, and combinations thereof, and typical hydrocarbon solvents like isododecane, alcohol, methylethylketone, etc., and combinations thereof; It is appreciated that the inclusion of a surfactant promotes miscibility of reactive silicone silanes in silicone oil and/or hydrocarbon based solvents. In some inventive embodiments, the organic solvent is VOC exempt. As used herein, “VOC” is defined as a compound listed on the United States Environmental Protection Agency Master List of Volatile Organic Compounds circa 2019.

An adhesion promoter is present in some inventive embodiments to promote bonding of the reactive silicone and graphene to the trim substrate. It is appreciated that some adhesion promoters operative herein function in as a cure promoter for the reactive silicone silane when present at high concentrations. The loading of an adhesion promotor in amounts to promote cure are readily determined by a study of time of cure as a function of concentration. Adhesion promoters operative herein illustratively include N-2-aminoethyl-3-aminopropyltrimethoxysilane, aminopropyltriethoxysilane, C₂-C₂₄ carboxamides, bis [3-(triethoxysilyl)-propyl]tetrasulfide-3-mercapto, 2(diphenylphosphino)ethyl triethoxysilane, N-vinylbenzyl-N-2(trimethoxysilylpropylamino)ethyl silane, trimethoxysilylpropyl-diethylenetriamine, 3-aminopropylmethyldiethoxysilane, 3-(1-aminopropoxy)-3-3-dimethyl-1-propenyl-trimethoxysilane, 1-trimethoxysilyl-2-(m,p-chloromethyl)phenylethane, trimethoxysilylpropyl-substituted polyethylene-imine, and combinations thereof.

To the extent an adhesion promoter or combination of promotors do not cure with a desired speed, a separate cure catalyst for the silanol functional present is provided. Such cure catalysts illustratively including metal carboxylates, metal oxides, alkyl metal carboxylates, alkyl metal alkoxides and metal chelates. Exemplary specific catalysts include tetraalkyl titanate, tetraalkyl zirconate, dibutyltindiacetate, dibutyltindilaurate, dibutyltin dioctoate, dibutyltin dimalate, dibutyltin diacetate, stannous octoate, tin octylate, tetrabutyl titanate, dioctyltindilaurate, tetraisopropyltitanate titanium n-butoxide, zinc acetate, zinc 2-ethylhexanoate, and combinations thereof.

An inventive composition includes a silicone silane and graphene which is capable of forming a protective cured coating on a target substrate.

An inventive composition in some embodiments also contains a fluorocarbon or hydrocarbon propellant when aerosol delivery is desired. In other embodiments, inventive compositions are applied by consumers by a simple trigger spray or simply by sponging or wiping onto a target substrate.

In certain embodiments of the invention, a leveling agent is present in an amount to impart uniform thickness of the composition to the extent that the composition is able to form a smooth finish on a target surface of a substrate. A leveling agent is chosen that is compatible with the silicone silanes system in the carrier. Leveling agent operative herein illustratively include various classes of surfactants: silicone surfactant, such as polyether-modified polysiloxane; anionic, such as linear alkylbenzene sulfontaes, alcohol sulfates, alcohol ether sulfates, alcohol ethoxylated sulfates, alpha olefin sulfonates, alphasulfomethyl ester; and nonionic, such as alcohol ethoxylates, alkyl phenol ethoxylates. A leveling agent, if present, in an inventive composition is present from 0.05 to 15 total weight percent.

In certain embodiments of the invention, various additives enhance a property of an inventive composition; the property illustratively including storage stability, film formation, film durability and cleaning properties. Additives are provided such as a dye to modify the color of an inventive composition, glitter particulate, a bitterant such as a denatonium benzoate, a light stabilizer, a defoamer, a corrosion inhibitor, fragrance, a surfactant, a UV agent, or combinations thereof. Each additive independently is typically in an inventive composition in an amount from 0 to 3 total weight percent, while in other specific embodiments, each is present from 0.01 to 0.5 total weight percent.

A defoaming agent is present in certain inventive embodiments in an amount present to inhibit surfactant foaminess, if desired, and allow for smooth formation of a hydrophobic film produced from an inventive composition. Defoamer agents operative herein illustratively include silicone-based defoamers; mineral oil-based defoamers, and mixtures of foam destroying polymers and hydrophobic solids such as polyureas, as are known to the art. Specific exemplary silicone-based defoamers illustratively include silica-filled polydimethyl siloxane and polyether-modified polysiloxanes.

An optional UV stabilizer imparts resistance against UV radiation. Examples of UV stabilizers are benzotriazoles, benzophenones, triazines, hindered amine light stabilizers, 2-(benzotriazol-2-yl)-4-(2,4,4trimethylpentan-2-yl) phenol, 3,5-di-t-butyl-4-hydroxybenzoic acid, hexadecyl ester and combinations thereof.

A preservative is optionally present in an embodiment of the inventive composition. A preservative prevents microbial degradation and offers long term stability and increases the overall stability of the composition. Preservatives operative herein illustratively include biphenyl-2-ol (ortho phenylphenol), 4,4-dimethyloxazolidine, 5-bromo-5-nitro-1,3-dioxane, 2-bromo-2-nitropropane-1,3-diol, 2,4-dichlorobenzyl alcohol, 5-chloro-2-(2,4-dichlorophenoxy)-phenol, 4-chloro-3,5-xylenol, 3,3′-bis-(1-hydroxymethyl-2,5-dioxoimidazolidinyl-4-yl)-1,1′-methylenedlurea (imidazolidinyl urea), poly(l-hexamethylene biguanidine hydrochloride), 2-phenoxyethanol, hexamethylenetetramine, benzyl alcohol, 1,3-bis-(hydroxymethyl)-5,5-dimethylimidazolidone-2,4-dione, 5-chloro-2-methylisothiazol-3(2H)-one, 2-methyl-isothiazol-3(2H)-one, benzisothiazolinone, 2-benzyl-4 chlorophenol, chlorhexidine and its digluconate, diacetate, and dihydrochloride salts, 1-phenoxy-propan-2-ol, cetyl pyridinium bromide and chloride, N-(hydroxymethyl-N-dihydroxymethyl-1,3-dioxo-2,5-imidazolinidyl-4)-N′-hydroxymethyl urea, sodium hydroxymethylglycinate, benzethonium chloride, benzalkonium chloride, bromide and saccharinate, 3-iodopropynylbutylcarbamate, benzisothiazolinone, triacetin, diazolidinyl urea, and cis-1-3-chloroallyl-3,5,7-triaza-1-azoniaadamantane chloride, and combinations thereof. Typically, a preservative is added in an amount of from about 0.05 to 1 total weight percent.

An inventive composition is readily stored in glass; metal; or plastic containers made of plastics such as polyethylenes, polypropylenes, nylons, PVC, or PET; or aerosol cans; or soaked wipe substrate; woven and non-woven substrates; or sponges.

While it should be appreciated that there is virtually no limit as to the nature of a substrate to which an inventive composition is applied to as to form a protective film, with the proviso that the substrate is not dissolved or otherwise damaged through exposure to an inventive composition.

An inventive composition optionally includes a halocarbon or hydrocarbon propellant in instances when an aerosol delivery system of an inventive composition is desired. Aerosol propellants operative herein illustratively include difluoroethane, trifluoroethane; alkanes such as butane, pentane, isobutane; propane; ethers such as dimethyl ether and diethyl ether; nitrogen; carbon dioxide; and combinations thereof. The resultant formulation inclusive of a propellant is sealed within a conventional metal aerosol canister and applied by spray application as is conventional to the art.

A process of application for an inventive composition to a surface includes the step of applying the composition to a substrate such as vehicle trim, plastic headlights, or molding. An inventive composition is readily applied to a substrate by swabbing, pump spray, or by application from a spray aerosol can or wipe. Silanols from the composition are allowed to cure and form the composite matrix with graphene to form a protective film layer on the substrate. The coating producing the shine and hydrophobicity is able to maintain durability subsequent to the application for several months under normal vehicle operating conditions. The protective film formed protects restores degraded trim and molding surfaces while also protecting against mud, dust, dirty rain, water spots, and grime. The film forming process seals pores making the surface hydrophobic and having less surface roughness further contributing to the shine of the treated surface with such a coating formed from an inventive composition. In some embodiments, the graphene domain size and content are such that the resulting coating is transparent to an unaided, normal human eye. The film also forms a bonding to the surface resulting in a sacrificial layer that is water and car wash resistant. These film layers repel dust and water and makes the surface easier to clean.

Compositions according to the present inventions are provided in Table 1.

TABLE 1
Inventive Composition - (amounts in total weight
percent exclusive of optional propellant)

| Ingredient | Typical |
|---|---|
| Adhesion promoter | 1-40 |
| Graphene | 0.005-30 |
| Reactive silicone silane | 1-80 |
| Catalyst | 0-5 |
| Additives | each |
| | 0-3 |
| Carrier | remainder |

An inventive composition is readily provided as a kit in the form of a bottle, wipe, sponge, or aerosol canister. The bottle optionally equipped with a pump- or spray-trigger, a flip-top or a spout closure. With the provision of an optional wipe remove excess composition, along with instructions for doing so, an inventive kit is operational. The instructions providing details as how to prepare a substrate, apply the inventive composition, removal of excess from the substrate and the time and properties of the film so applied. The instructions can also provide details as to how the composition is re-applied after an applied film is worn.

The present invention is further detailed with respect to the following non-limiting examples that are provided to further illustrate the preparation of specific inventive compositions and certain attributes associated with the resulting films on substrates.

### Example 1

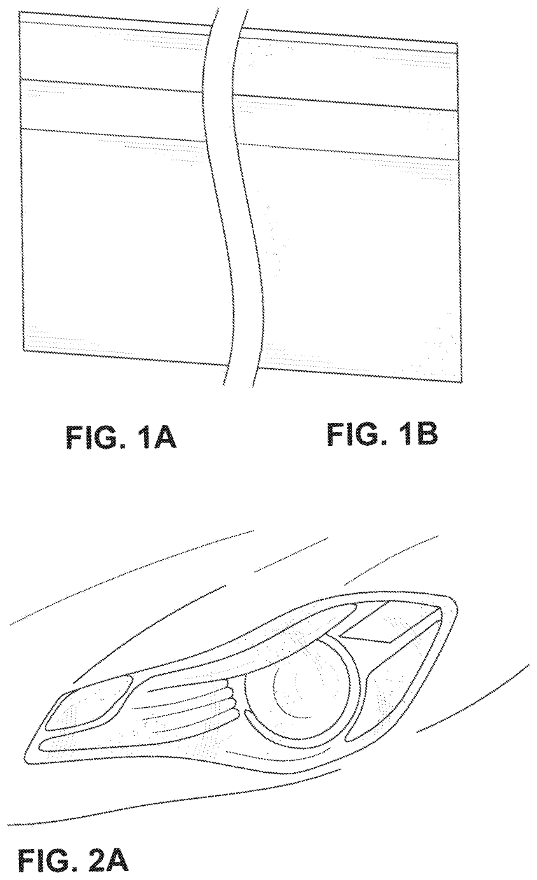

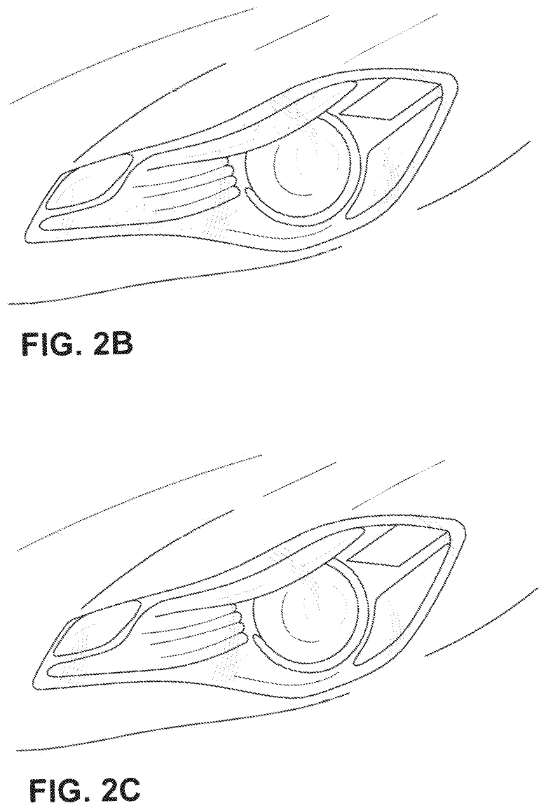

A composition of 29.8 total weight percent light weight silicone oil, 50 total weight percent methoxy-terminated polysilsesquioxanes resin, 0.2 total weight percent solvent graphene slurry, and 20 total weight percent adhesion promoter is applied to a faded trim part as shown in FIG. 1A. The composition is applied using a sponge and wipe. The composition demonstrates no leveling issues. The composition provides high shine to the trim part per ASTM D523, as shown in comparison to the untreated portion of the trim part of FIG. 1B. Even after five months, the shine of the coating is still visible as shown in FIG. 1A. Similar composition was applied as headlight sealant. The aged headlight has hazy surface as shown in FIG. 2A. It was wet sanded, and then to which was applied the composition to provide optical clarity and protection to the headlights (FIG. 2B). After 5 months, the treated headlight shown in FIG. 2B remained clear and protected from weathering (FIG. 2C).

### Example 2

The composition of Example 1 is sealed in a conventional metal aerosol canister with gaseous nitrogen as a propellant. The canister mixture is applied by spray application to the same substrates as Example 1 with excess liquid being removed from the substrate surface. The resulting film coated substrates are tested and perform in a similar manner as to those in Example 1.

Patents and publications mentioned in the specification are indicative of the levels of those skilled in the art to which the invention pertains. These patents and publications are incorporated herein by reference to the same extent as if each individual patent or publication was specifically and individually incorporated herein by reference.

The forgoing description is illustrative of particular embodiments of the invention, but is not meant to be a limitation upon the practice thereof. The following claims, including all equivalents thereof are intended to define the scope of the invention.

1. A restorative and protective composition comprising:
a curable silicone silane having silanol groups;
a graphene slurry;
an adhesion promoter; and
a carrier that is liquid at 20 degrees Celsius at atmospheric pressure in which said curable silicone silane, said graphene slurry, and said adhesion promoter are dissolved or dispersed.

2. The composition of claim 1 wherein said silicone silane is at least one of polysilsesquioxanes resin, silicone MQ resin, silicone MQT resin, or combinations thereof, with the proviso that at least one reactive group is present is said silicone silane.

3. The composition of claim 1 wherein said silicone silane is present from 1 to 80 total weight percent of the composition.

4. The composition of claim 1 wherein said carrier comprises a silicone oil, a hydrocarbon solvent, or combinations thereof.

5. The composition of claim 4 wherein said silicone oil includes at least one of decamethylpentasiloxane, hexamethylcyclotrisiloxane, octamethylcyclo-tetrasiloxane, or oligiomeric forms thereof to achieve viscosities of from 2 to 10,000 centistokes (cSt) per ASTM D1200-10.

6. The composition of claim 1 wherein said adhesion promoter is present from 1 to 40 total weight percent of the composition.

7. The composition of claim 1 wherein said adhesion promoter is N-2-aminoethyl-3-aminopropyltrimethoxysilane, aminopropyltriethoxysilane, C2-C24 carboxamides, bis [3-(triethoxysilyl)-propyl]tetrasulfide-3-mercapto, 2(diphenylphosphino)ethyl triethoxysilane, N-vinylbenzyl-N-2(trimethoxysilylpropylamino)ethyl silane, trimethoxysilylpropyl-diethylenetriamine, 3-aminopropylmethyldiethoxysilane, 3-(1-aminopropoxy)-3-3-dimethyl-1-propenyl-trimethoxysilane, 1-trimethoxysilyl-2-(m,p-chloromethyl)phenylethane, trimethoxysilylpropyl-substituted polyethylene-imine, and combinations thereof.

8. The composition of claim 1 wherein said adhesion promoter is present in an amount that increases a cure rate of said curable silicone silane.

9. The composition of claim 1 further comprising a catalyst.

10. The composition of claim 1 further comprising at least one additive of a dye, a fragrance, a leveling agent, a UV agent, a glitter particulate, a bitterant, a light stabilizers, a defoamer, a corrosion inhibitors, or combinations thereof.

11. The composition of claim 1 wherein said graphene slurry is present from 0.005 to 30 total weight percent of the composition.

12. A process for applying a restorative and protective coating to a target substrate comprising:
applying the composition of claim 1 to the target substrate; and
allowing sufficient time for composition to cure onto the target substrate.

13. The process of claim 12 wherein applying is with a spray or a soaked wipe.

14. The process of claim 12 wherein applying is with an aerosol propellant.

15. The process of claim 12 wherein the target substrate is vehicle trim.

16. The process of claim 12 wherein the target substrate is a vehicle tire or headlights.

17. An article comprising:
a vehicle trim piece or a vehicle tire or a headlight; and
a coating resulting from the cure of a composition of claim 1 adhered to a surface of said vehicle trim piece or said vehicle tire or said headlight.

18. The article of claim 17 wherein the vehicle trim piece is a vehicle exterior trim piece.

19. The article of claim 17 wherein the vehicle trim piece is a vehicle exterior trim or plastics.
